(19) United States
(12) Patent Application Publication
(10) Pub. No.: US 2008/0212953 A1
(43) Pub. Date: Sep. 4, 2008

(54) Optical Disc Recording/Reproducing Apparatus

(75) Inventor: Keiji NAGAYAMA, Hitachinaka (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 12/110,725

(22) Filed: Apr. 28, 2008

Related U.S. Application Data
(63) Continuation of application No. 10/093,624, filed on Mar. 7, 2002.

(30) Foreign Application Priority Data
Feb. 12, 2002 (JP) 2002-033320

(51) Int. Cl. H04N 5/00

(52) U.S. Cl. 386/126

(57) ABSTRACT

An optical disc recording/reproducing apparatus, comprises: a thumbnail data production portion for extracting the head pictures of all video data recorded, as thumbnail data; a memory portion of the thumbnail data; a thumbnail list production portion for producing thumbnail list display data upon the basis of the thumbnail data from the memory portion; and a thumbnail controller portion for controlling the above, wherein finalizing process is executed from a list displayed on a screen of the thumbnail pictures, thereby enabling a user to confirm the recorded contents on the pictures thereof.

### CROSS-REFERENCE TO RELATED APPLICATIONS

This is a continuation of U.S. patent application Ser. No. 10/093,624, filed on Mar. 7, 2002, which application claims priority from Japan Patent Application No. 2002-033320, filed Feb. 12, 2002, the entire disclosures of both of which are incorporated herein by reference.

### BACKGROUND OF THE INVENTION

1. Field of the Invention

The present invention relates to an optical disc recording and/or reproducing apparatus, and in particular to a technology of a list display of so-called thumbnail picture when conducting finalizing process, etc.

### BRIEF SUMMARY OF THE INVENTION

2. Description of Prior Art

In recent years appears a recording/reproducing apparatus of using an optical disc, such as, DVD-RAM, etc. The regulation of optical discs classifies DVDs into: a re-writable type, being represented by, such as DVD-RAM, on which information can be re-written or re-recorded; and a write-once type, being represented by, such as, DVD-R, on which it is difficult to re-write information if it was recorded once. On the DVD-RAM, as a representative one of such the re-writable media, recording and erasing can be conducted repeatedly, however the DVD-R, as the representative one of the write-once type media, has a feature that picture that was once recorded thereon cannot be erased easily. Also, although the reproduction of the re-writable type DVD-RAM is able by only the reproducing apparatus corresponding thereto, however the write-once type DVD-R has a feature that it can be reproduced by means of a DVD player (i.e., the reproducing apparatus) that is widely available, if being conducted by the finalizing process is thereon. Therefore, the recording/reproducing apparatus being able to record on the DVD-R comes to increase in the number thereof.

In the recording/reproducing apparatus utilizing such the optical disc therein, in many cases, for the purpose of utilization of a random accessing property thereof, a so-called thumbnail pictures, each being a small-sized picture of a representative scene of the pictures inputted or recorded, are displayed on a monitor, in the form of a list, thereby improving the capacity of searching for an aimed picture. Herein, displaying of the thumbnail pictures is called by “navigation (or navigation picture)”.

As one of methods for showing up the navigation picture (hereinafter, being abbreviated by “navi screen”), a method disclosed, for example, in Japanese Patent Laying-Open No. 2001-11963 (2001) is practiced actually. This discloses a method, in which thumbnail data (i.e., small-sized picture data) for displaying the thumbnail pictures are produced when recording, and are recorded into a recording region or area, being separate from that for the picture data to be recorded, such as, the region for TOC (Table Of Contents) information or a unique region for exclusive use thereof. The region on which the data are recorded can be discontinuous when the optical disc is of the re-writable type, therefore the system is so constructed that a region is prepared for recording the thumbnail data therein, thereby the thumbnail data can be recorded when recording. Also, even if there is no thumbnail data, it is possible to produce a list data of thumbnails by reading picture files into when reproducing, thereby to record them into the region for use of the thumbnail data. However, when the optical disc is of the write-once type, since the data to be recorded must be written into, sequentially and continuously, therefore the system is so constructed that the thumbnail data are not recorded in such the separate region.

On a while, the write-once type optical disc, such as, DVD-R, has a feature that it can be reproduced by a DVD player that is generally and widely used, if being conducted with a process at an end terminal of the writing, being so-called by “finalizing”. As an operating method for conducting the finalizing process, it is common to select an item of the finalizing from a menu display, etc., thereby, conducting that process, in the process. Such the method as mentioned above is described, for example, on page 55 of Instruction manual of DVD video recorder “DMR-E20” manufactured by Matsushita Electric Industry Co., Ltd., and on pages 32-33 of Instruction manual of a digital still camera “DVC-CD200/CD300” manufactured by Sony Co., Ltd. On the DVD video recorder “DMR-E20” manufactured by Matsushita Electric Industry Co., Ltd., for example, when the item “Finalizing” below “Disc Management” is selected from a menu display called by “Top Window”, then the finalizing process is conducted. On the screen in this instance are displayed, such as, the number of programs, recording time, remaining capacity, the number of markers by characters, as the contents of the optical disc, and therefore, the contents of the optical disc to be processed with such finalization thereon can be confirmed by the means of or in the form of character information.

However, according to the conventional technology mentioned above, in case of the write-once type optical disc, the thumbnail data cannot be recorded into the region separate from that of the recording picture data when recording, then no consideration was paid upon displaying a list of thumbnail pictures (i.e., the navi screen) in the write-once type optical disc. Therefore, because of no display of the list of thumbnail pictures (i.e., the navi screen) in the case of the write-once type optical disc, the contents thereof can confirm by only in the form of character information but not by themselves (i.e., not through the navi screen). For this reason, sometimes, it is impossible to jump to the picture that a user wishes to look at, therefore brings about a problem that it is inconvenient from a viewpoint of searching property thereof. Further, when the user tries to conduct the finalizing process on the write-once type optical disc before the finalizing process thereon, she/he can confirm only the number programs, recording time, remaining capacity, the number of markers, etc., but only through the character information, by the method of confirming the recording contents of the optical disc, therefore there is a problem that they cannot be confirmed by the pictures thereof. Moreover, upon the operation calling for the navi screen, since the navi screen cannot be displayed in the case where the write-once optical disc is loaded, a means is necessary for rejecting the operation or for alarming, etc., and the apparatus operates or functions differently even on the same operation by the user, thereby bringing about a possibility of causing confusion to the user, and being inconvenient in the operability thereof.

### SUMMARY OF THE INVENTION

An object, according to the present invention, for dissolving the drawbacks of such the conventional arts, is to provided an optical disc recording/reproducing apparatus, being able to display the thumbnail pictures of the recording contents in the form of a list, not only when using the write-once optical disc therein, but also when conducting the finalizing process thereon, thereby enabling confirmation of the contents through the pictures, video or image thereof.

For dissolving such the problem(s) mentioned above, according to the present invention, there is provided an optical disc recording/reproducing apparatus, comprising: a reproduction process portion for conducting reproduction process of at least video data and management information recorded on a removable external recording medium; a thumbnail data reproduction portion for extracting and producing data for use of thumbnail pictures from video data from said reproduction process portion; a memory portion for memorizing thumbnail data from said thumbnail data production portion; a thumbnail list production portion for producing data for use in displaying of a list of the thumbnail pictures on one screen display; a video signal process portion for converting list display data of the thumbnail pictures into analogue video signals; an input portion for inputting operation of information; and a thumbnail controller portion for controlling said thumbnail data production portion and said memory portion and said thumbnail list production portion, wherein, in a case where a predetermined first operation is made from said input portion when a write-one type optical disc is loaded, as said the external recording medium; said thumbnail controller portion reads out a recording position of each of the video data from management information on said write-once type optical disc, respectively; the thumbnail data of an arbitrary number of pictures for each of said video data are extracted and produced by said thumbnail data production portion; the thumbnail data produced are memorized in said memory portion, sequentially; and the thumbnail list display data are produced from the data of said recording portion by said thumbnail list production portion, whereby displaying the list of the thumbnail pictures.

Further, according to the present invention, there is provided the optical disc recording/reproducing apparatus, as described in the above, wherein said write-one type optical disc is an optical disc before being conducted with finalizing process thereupon. According to this, in the case of the write-once type optical disc, the thumbnail data can be also produced before being conducted with the finalizing process thereon, so as to display a navi screen as display of a list of the thumbnail pictures, thereby improving searching ability.

Furthermore, according to the present invention, there is also provided the optical disc recording/reproducing apparatus, as described in the above, further comprising: a recording process portion for conducting the finalizing process, wherein, when conducting the finalizing process on the write-once type optical disc, the finalizing process is conducted through a predetermined second operation after displaying the list of the thumbnail pictures through said first predetermined operation. According to this, when conducting the finalizing process, a user can operate it from the navi screen displayed, and thereby she/he can confirm the recording contents on the picture thereof.

Furthermore, according to the present invention, there is also provided the optical disc recording/reproducing apparatus, as described in the above, further comprising: a controller portion for determining the external recording medium loaded in kind thereof, wherein, data is produced for displaying the kind of said external recording medium within said thumbnail list display data, and a first display is made when the finalizing process is not made on the write-once type optical disc loaded, while a second display when the finalizing process is made thereupon. According to this, the display changes before and after the finalizing process in the case of the write-once type optical disc, therefore visibility can be improved.

And, further, according to the present invention, there is also provided the optical disc recording/reproducing apparatus, as described in the above, further comprising: a controller portion for determining the external recording medium loaded in kind thereof; and a controller portion for determining the kind of the external recording medium, and upon basis of a result of determination, for producing the thumbnail list display data upon basis of the thumbnail data on said external recording medium, when the data for use of the thumbnail pictures lies on said external recording medium, wherein a process for producing the thumbnail list display data, by determining the kind of the external recording medium, corresponding to the recording medium, for each, when a predetermined operation is made. According to this, since the navi screen can be displayed irrespective of the kind of the optical disc, usability can be increased.

Thus, according to the present invention, when conducting the finalizing process in the case of the write-once type optical disc, the user can make a list the contents displayed, thereby to confirm it/them on the picture(s).

### BRIEF DESCRIPTION OF THE DRAWINGS

Those and other features, objects and advantages of the present invention will become more apparent from the following description when taken in conjunction with the accompanying drawings wherein:

FIG. 1 is the structure view for showing one of an optical disc recording/reproducing apparatus, according to the present invention;

FIGS. 2(a) and 2(b) show an example of a screen of a list of thumbnail pictures, according to the present invention;

FIG. 3 shows an example of cursor buttons and a decision button to be used in selection of the thumbnail pictures, according to the present invention;

FIGS. 4(a) to 4(c) show an embodiment of a menu function screen, according to the present invention;

FIGS. 5(a) to 5(d) show an embodiment of a display screen when conducting finalizing process, according to the present invention;

FIG. 6 is a flowchart for showing the entire of flows in the embodiment according to the present invention; and

FIG. 7 is a flowchart for showing flows in thumbnail producing process in the embodiment according to the present invention.

### DETAILED DESCRIPTION OF PREFERRED EMBODIMENTS

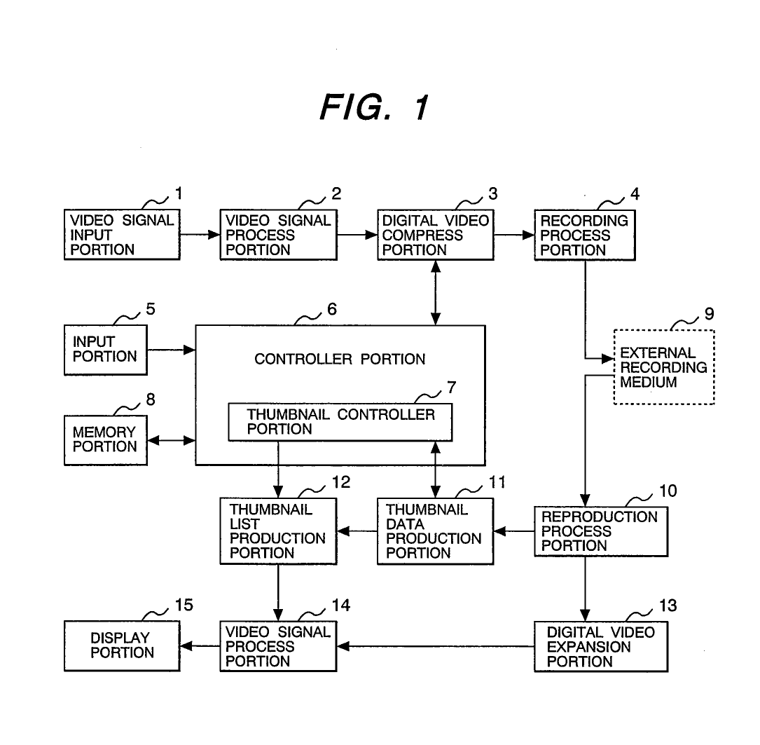

Hereinafter, embodiments according to the present invention will be fully explained by referring to the attached FIGS. 1 through 7. In the present invention, it is presumed that, an optical disc recording/reproducing apparatus is applicable to both external recording media; such as, DVD-RAM and/or DVD-RW, as the re-writable type optical disc; while such as DVD-R, as the write-once type optical disc. However, in those drawings, the same reference numerals are given to the same or similar elements or portion in the embodiment.

FIG. 1 is the structure view for showing one of the optical disc recording/reproducing apparatus according to the present invention. In this FIG. 1, a reference numeral 1 indicates a video signal input portion; 2 a video signal processing portion for conducting various processes upon signals, for example, conversion of the video signal into digital signals, etc.; 3 a digital picture compression portion for producing compressed data of the digital picture signals; 4 a recording process portion for recording the compressed data and various kinds of data on the external recording medium; 5 an input portion, including such as, a disc navi button, a menu button, cursor buttons, a decision or determination button, to be used for conducting the finalizing process therewith; 6 a controller portion for conducting a decision on the kinds of the external recording media, as well as, for conducting various kinds of controls on the present apparatus, as a while; 7 a thumbnail controller portion for conducting various kinds of controls, so as to produce thumbnail data for an optical disc, i.e., the external recording medium; 8 a memory portion for memorizing the thumbnail data therein; 9 the external recording medium (outside the present apparatus), such as the optical disc, etc., that can be loaded and removed freely (i.e., being removable); 10 a reproducing process portion for reproducing video data, the thumbnail data, management information data, etc., on the external recording medium 9 (hereinafter, being called by an “optical disc”); 11 a thumbnail data production portion for extracting and producing data for use of the thumbnail pictures on the basis of the video data provided from the reproducing process portion 10; 12 a thumbnail list production portion for producing data for use of displaying a list of thumbnail screen on a display on the basis of the thumbnail data from the memory portion 8; 13 a digital video expansion (or decompression) portion for expanding or decompressing the compressed data recorded on the optical disc 9; 14 a video signal processing portion for conducting various kinds of processes upon signals, as well as, for converting the expanded data from the digital video expansion portion 13 and the data from the thumbnail list production portion 12 into analogue signals; and 15 a display portion or unit on which the signals converted into analogue are displayed, respectively. Herein, the display portion 15 may be constructed to be an external display device or apparatus separate from the present apparatus.

Herein, explanation in more details of the respective portions I through 15 is, as below:

The video signal input portion indicated by 1 is made from a device or apparatus for inputting video signals from a camera, and/or video signal, etc., from an external input, in the present embodiment. This input portion may be constructed with, not only a circuit connected by only wirings or terminals, but also with a receiver for receiving radio signal (e.g., a TV telephone, etc.), and also it may be a build-in tuner, etc.

Each the video signal processing portion shown by 2, the digital picture compression portion by 3, the recording process portion by 4, the controller portion by 6, the thumbnail controller portion by 7, the reproducing process portion by 10, the thumbnail data production portion by 11, the thumbnail list production portion by 12, the digital video expansion portion by 13, and the video signal processing portion by 14, may be built up with a circuit, or alternatively with processing conducted by a micro-computer software by using a micro-computer.

The operation buttons of the input portion shown by 5 also may be constructed with such operation buttons, respectively, as was mentioned preciously, or may be achieved by receiving of remote control code from a remote controller and/or remote control from the PC (i.e., RS-232C, etc.), for example.

The memory portion depicted by 8 may be made of a build-in memory or the like. The external recording medium (outside the present apparatus) depicted by 9 is a freely loadable or removable external recording medium, such as, an optical disc, etc., and it may includes the write-once medium which necessitates the finalizing process, or may be constructed by an optical recording/reproducing apparatus, etc.

The display portion depicted by 15 may be built up with a circuit, or may be LCD, EVF, an external output (i.e., TV, etc.).

Next, explanation will be given briefly, on the flows of signals in production of the thumbnail pictures when the write-once type optical disc 9 before being conducted with the finalizing process thereon is loaded in, and also of signals for displaying a list of the thumbnail pictures. When the disc navi button (not shown in the figure) of the input portion 5 is pushed down, under control of the controller portion 6, a position of video object data is read out from the management information region or area on the optical disc 9 through the reproduction process portion 10, thereby video object at a target is reproduced. Under control of the thumbnail controller portion 7, the video or picture at a head of the video object is extracted by the means of the thumbnail data production portion 11, thereby producing the thumbnail data thereon. The thumbnail data produced are memorized through the thumbnail controller portion 7 into the memory portion 8. This operation will be repeated by the number of all the video objects recorded on the optical disc 9, or a predetermined number of the video objects.

Next, the thumbnail data of an arbitrary number thereof, at least one (1) or more, of the video objects memorized within the memory portion 8 is read out, and then the thumbnail list display data are produced in the thumbnail list production portion 12. Herein, as such the thumbnail data of arbitrary number, for example, twelve (12) pieces of the thumbnail data are read out, in a system of displaying twelve (12) pieces of the thumbnail pictures on a display screen. Also, in the case that the number of the thumbnail data is less than twelve (12) in pieces, all the thumbnail data are read out.

The thumbnail list data are converted into analogue data in the video-signal processing portion 14, and are added with various kinds of information thereof, such as character information, together, thereby a screen for a list of the thumbnail pictures is displayed on the display portion 15 as the navi screen. After this, the user can conduct the finalizing process by the means of the menu button (not shown in the figure) and the cursor buttons, etc., of the input portion 5, while seeing or watching the list of thumbnail pictures displayed on the navi screen.

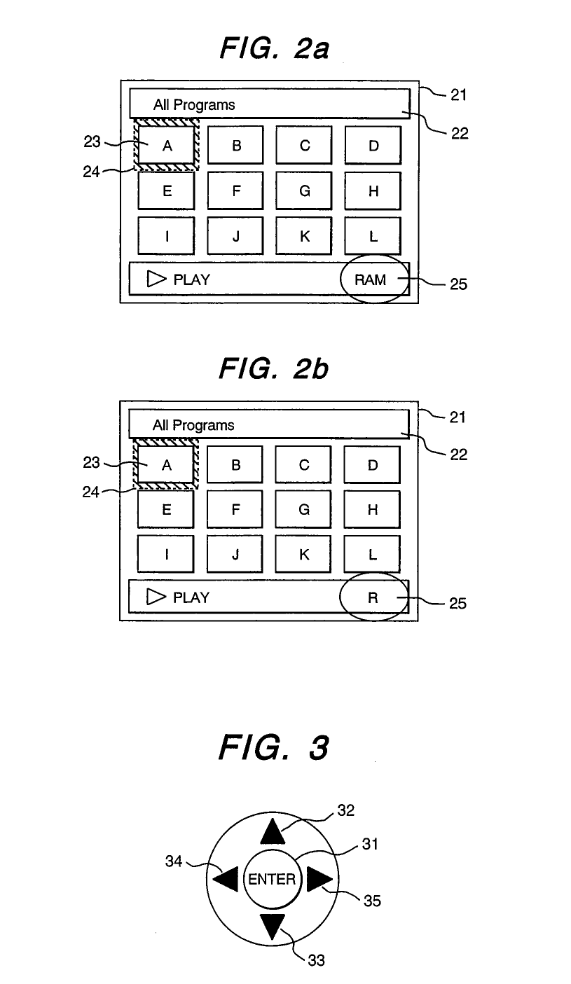

Next, explanation will be given on an example of the display of the list of thumbnail pictures displayed on the navi screen and an operation for reproduction of video pictures from the list of the thumbnail pictures displayed on the navi screen, by referring to FIGS. 2(a), 2(b) and 3.

FIGS. 2(a) and 2(b) show an embodiment of the displayed screen (herein after, being called by the “navi screen”) of the list of the thumbnail pictures, according to the present invention. In particular, FIG, 2(a) shows the navi screen displayed when the DVD-RAM disc is inserted or loaded into, and FIG. 2(b) that when DVD-R disc is inserted or loaded into. FIG. 3 shows an embodiment of the cursor buttons and the decision button provided in the input portion 5 for use in selection of the thumbnail pictures and for use in selection of various items. In those FIGS. 2(a) and 2(b), a reference numeral 21 is the navi screen as a whole; 22 a display of contents at the present time; 23 the thumbnail pictures (i.e., twelve (12) pieces from “A” to “L” are shown in this figure); 24 an indication of cursor position for indicating the thumbnail picture selected; and 25 and 26 kinds of the optical discs 9 loaded into, respectively. In case of the DVD-RAM disc, “RAM” is displayed, while “R” if the DVD-R. Also, when other kind of optical disc is loaded into, the display is made at this position for discriminating the optical disc loaded into in the kind thereof. However, the display is changed between before and after the finalizing process thereon, in the case of the DVD-R disc, in the present embodiment, but this will be mentioned later.

Also herein, the loaded optical disc 9 is determined on the kind thereof, and the methods for extracting thumbnail data and the methods for producing the thumbnail list data are switched or changed over depending upon the kind thereof, appropriately, thereby to be displayed, but this will be mentioned later.

In FIG. 3, a reference numeral 31 depicts the decision (“ENTER” in the figure) button for deciding the item selected; 32 an upper cursor button for moving in an upper direction; 33 a lower cursor button for moving in a lower direction; 34 a left-hand cursor for moving in the left-hand side direction; and 35 a right-hand cursor for moving in the right-hand side direction, respectively.

Next, explanation will be given on the operation when reproducing the thumbnail picture “B”. First of all, when the disc navi button (not shown in the figure) in the input portion 5 is pushed down, the screen appears, as shown in FIG. 2(a) or 2(b). Since the present cursor position indication 24 is at the position of the thumbnail picture “A”, the right-hand cursor button 15 is pushed down by one (1) time, so as to move the present cursor position indication 24 to the thumbnail picture “B”, and thereafter the reproduction button of the input portion 5 is pushed down, thereby it is possible to reproduce the aimed or targeted video object.

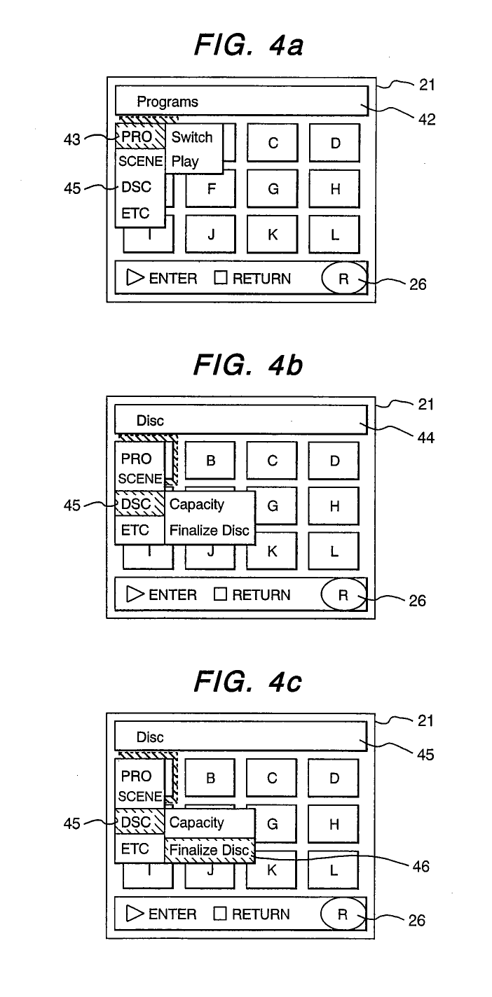

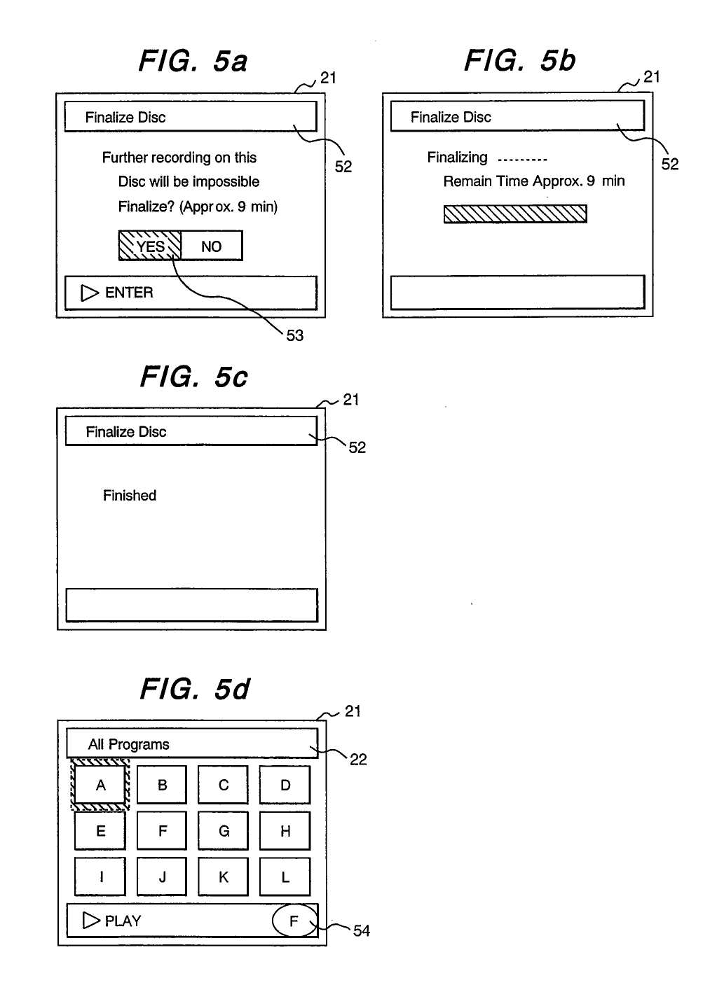

Next, by referring to FIGS. 4(a) through 5(d), explanation will be given on the operation method and the screen display for conducting the finalizing process from the navi screen, in particular, on the DVD-R disc before the finalization is conducted thereon. FIG. 4(a) shows a menu function screen displayed when the menu button (not shown in the figure) is pushed down from the navi screed shown in the FIG. 2(b); FIG. 4(b) a display screen when further “DSC” is selected by means of the lower cursor button 33; FIG. 4(c) an example of the screen displayed when further “Finalize Disc” is selected by means of the right cursor button 35 and the lower cursor button 33. FIG. 5(a) shows a confirmation screen on starting of the finalizing process when the decision button 31 is pushed down, after the selection of the “Finalize Disc” shown in the FIG. 4(c); FIG. 5(b) a screen displayed during the finalizing process when further the start of that process is selected; FIG. 5(c) a screen displayed when the finalizing process is completed or ended; and FIG. 5(d) an example of the screen displayed after the completion of the finalizing process.

On the navi screen shown in the FIG. 2(b), when the menu button (now shown in the figure) of the input portion 5 is pushed down, the contents on the present screen displayed is changed from that for all programs 22 to the program 42, wherein the menu programs of, such as, PRO (program) 43, DSC (disc) 45, etc., can be selected thereon. Herein, when the lower cursor is depressed down by two (2) times, the screen changes into that when the DSC (disc) 45 shown in the FIG. 4(b) is selected, and further when the right-hand cursor 35 and the lower cursor 33 are depressed by one (1) time for each, then the screen changes into that when the “Finalize Disc” 46 shown in the FIG. 4(c) is selected. During the time-period from FIG. 2(a) to FIG. 4(c), since the user can see the thumbnail pictures of the video objects recorded on the optical disc 9, then she/he can confirm the record contents by means of the pictures before the conduction of the finalizing process thereof. With this, it is possible to escape from mischievous finalization process of the optical disc.

Herein, it may be possible to display, not only the thumbnail pictures, but also together with character information, such as, the number of programs, the recording time, the remaining amount, the marker, etc.

When the finalizing process is determined or decided through the decision (“ENTER”) button 31 in FIG. 4(c), a portion of the contents displayed comes to be the screen 52 for use of the finalizing process, wherein “Finalizing. . . ” is displayed as shown in FIG. 5(b), when “YES” is selected and determined after the confirmation on whether the finalizing process should be executed or not, and then it turns into the screen for displaying the completion of the finalizing process as shown in FIG. 5(c). Thereafter, it turns back to the navi screen shown in FIG. 5(d). However, in this instance, since the finalizing process is completed on the DVD-R disc, the display “R” 26 indicating the kind of the optical disc changes into “F” 54.

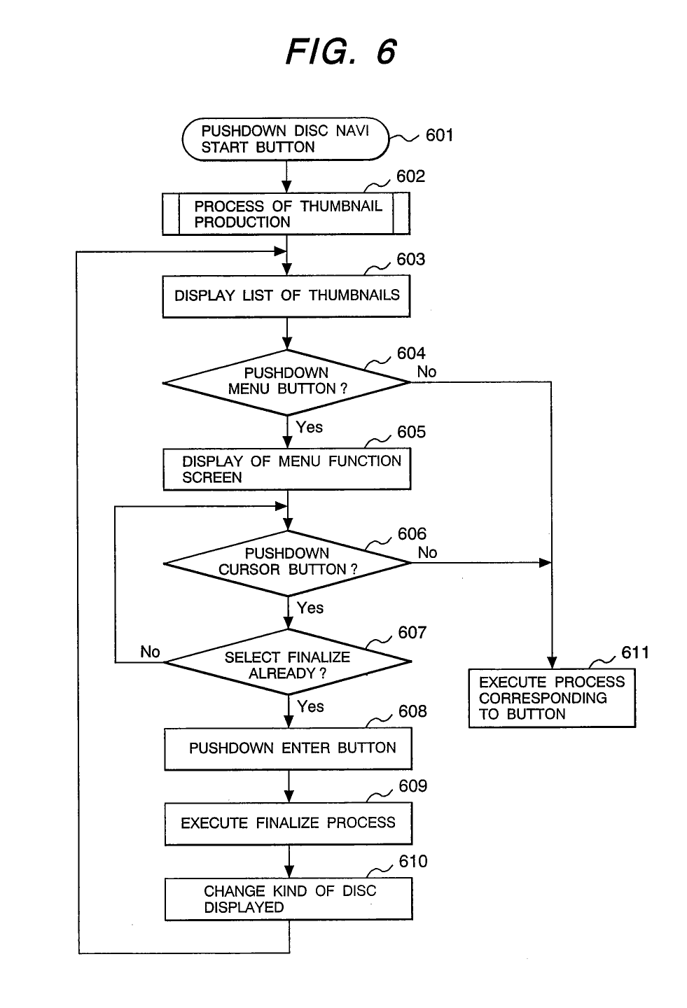

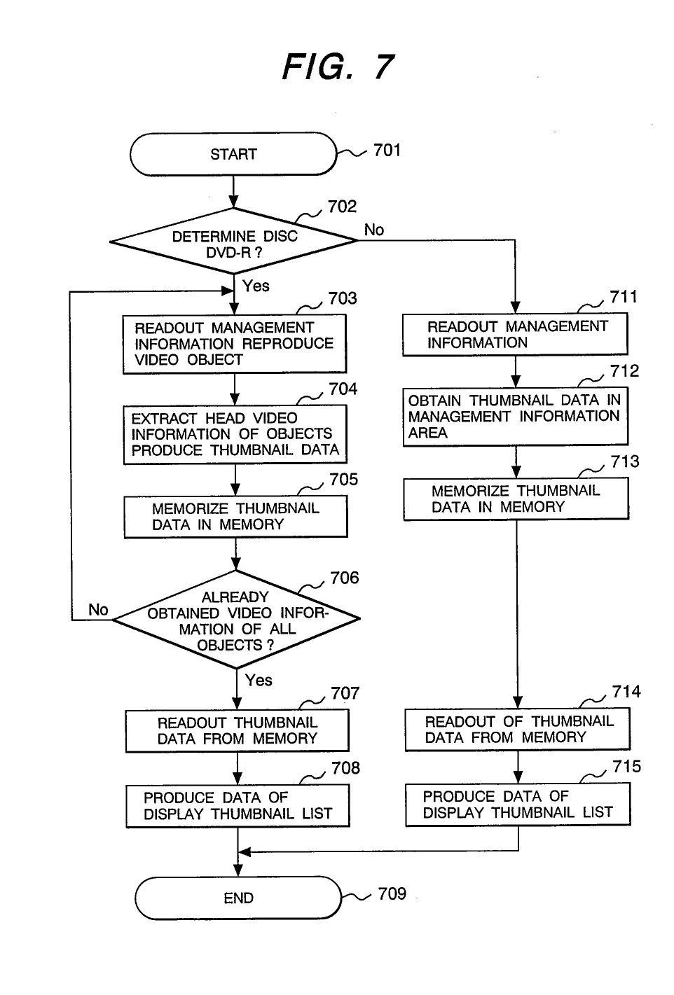

Next, by referring to FIGS. 6 and 7, explanation will be given on the processes for conducting the finalizing process from the display of the list screen (i.e., the navi screen) of the thumbnail pictures, in particular on the DVD-R disc before the finalization thereon, and also the steps of displaying the navi screen when other optical disc loaded into. FIG. 6 is a flowchart for showing flow of processes in the finalizing process, as a hole, according to one embodiment of the present invention. FIG. 7 is a flowchart for showing flow of processes in the thumbnail production process, as a whole, according to one embodiment of the present invention. First, the entire flow will be explained by referring to FIG. 6.

When the disc navi button (not shown in the figure) of the input portion 5 is pushed down (see the step 601), the thumbnail production process is conducted in the step 602, and the thumbnail list data are produced therein. In the step 603 is displayed the navi screen (see FIGS. 2(a) and 2(b)), thus, being the display of the list of thumbnail pictures, and then it waits for depression of the menu buttons (not shown in the figures) of the input portion 5. When the menu button (not shown in the figures) is pushed down in the step 604, the screen of the menu function appears (see FIG. 4(a)) in the step 605, and it wais for until when the “Finalizing Disc” 46 is selected in the steps 606 and 607. When the “Finalizing Disc” 46 is selected in the step 607, and then when the decision button 31 is pushed down in the step 608, the finalizing process is carried out in the step 609. When the finalizing process is completed, the display of “R” 26 for the kind of the optical disc 9 is changed into “F” 54 in the step 610, thereafter the display turns back to the navi screen in the step 603.

Herein, when the buttons other than the menu button and the cursor buttons are pushed down in the steps 604 and 606, respectively, then the processes corresponding to those will be executed. Also, in case of the optical discs other than the DVD-R and the DVD-RW of before formatting thereof, the display does not appear on the item of “Finalizing Disc”, on the menu screen (see FIG. 4(b)), so as not to allow the process to proceed to the step 607.

Next, explanation will be given on an example of the flow in the process for producing the thumbnail list data. When the process enters into the step 602 in FIG. 6 (in the step 701), determination is made on the kind of the optical disc 9 loaded into in the step 702. Herein, in the case where it was already determined when the disc is loaded into, it may be possible to substitute a confirmation process for that.

In the case of being the DVD-R disc as a result of the determination, the management data located in the region or area for the management information are read out in the step 703, thereby the video objects are reproduced, while the thumbnail data are produced by extracting the video data at the head thereof, in the step 704. The thumbnail data reproduced are memorized into the memory portion 8 in the step 705. In the step 706, it is confirmed whether the video information at the head of all the video objects recorded on the optical disc are obtained or not, and also on whether the thumbnail data are extracted and/or produced, and then the step turns back to the step 703, so as to repeats it until when obtaining the video data at the head of all the objects and the memorizing the thumbnail data therein. When it is confirmed, in the step 706, that the video information at the head of all the image objects are obtained and that the thumbnail data thereof are memorized, the thumbnail data of an arbitrary number, i.e., at least one or more, of the video objects are read out from the memory portion 8 in the step 707, and the thumbnail list screen data is produced in the step 708, thereby ending the processes (in the step 709). Thereafter, the navi screen is displayed in the step 603 in FIG. 6.

Herein, as the arbitrary number of thumbnail data, twelve (12) pieces of the thumbnail video are read out, for example, in the system of displaying twelve (12) pieces of the thumbnail pictures on one (1) screen of display. Also, in the case where the number of the thumbnail data is less than twelve (12), all the thumbnail data are read out.

When a result of the determination in the step 702 is other than the DVD-R disc, in the step 711 is read out the management information, which are located in the region or area for the management information on the optical disc. In this instance, since the thumbnail data are located within the management information or in the region or area for exclusive use thereof, the thumbnail data are read out in the step 712, and are memorized in the memory portion 8 in the step 713. And in the step 715, the thumbnail data are read out from the memory portion 8 in the step 714, and in the step 715, the thumbnail list display data is produced, thereby ending the processes (in the step 709).

Herein, the process may be made, so that it jumps from the step 712 to the step 715 without memorizing the thumbnail list display data into the memory portion 8.

In the present embodiment described in the above, though being made on all the video objects in the step 706, but it is also possible to handle, so as to display the navi screen when the video information of an arbitrary number of the video objects is obtained and when confirmed the thumbnail data thereof are memorized. For example, in the case where the number of the thumbnail pictures is twelve (12) on one screen of display, the video information of the twelve (12) pieces of video objects are obtained, to be memorized. In this instance, when the user wishes to display a further next navi screen (i.e., the thumbnail pictures), the video data of the video objects and the thumbnail data are obtained and memorized, when the operation is made on the next navi screen. With this, it is possible to shorten the time until displaying the navi screen. This is effective, in particular, in the case where the video objects recorded are large in the number thereof.

Also herein, if it is so constructed that the thumbnail data that were recorded once are held in the memory portion 8, there is no necessity of calling them into at every time, there by achieving an improvement in an operability, in particular, when calling up the previous navi screen, etc.

In the embodiment in the above, though being explained that timing of taking-in of the video for use of the thumbnail pictures is at the head video or picture of the video object(s), however it should not be restricted only to that, and it may also possible to take the video into at any timing.

In the present embodiment mentioned above, the explanation was made only about the example of the operations and displays by using the disc navi button, the menu button, the cursor buttons, etc., but it is needless to say that the operations and the contents displayed should not be restricted or limited to the above. For example, to the input portion, other than the buttons mentioned above, it may be possible to apply a mouse, a keyboard, a touch-panel, etc., for inputting.

In the present embodiment mentioned above, the explanation was made only on the processing from the step 703, even with the DVD-R disc after the finalization thereof, however in particular, in the case of the optical disc having the thumbnail data in the management information region or area, or the region or area for exclusive use thereof on the DVD-R disc, it may be possible to modify the process, so that the information in the management information region or the region for exclusive use thereof is read out next to the step 702, and/or that the processes from the step 711 are conducted when the thumbnail data are detected.

The processing method explained in the present embodiments mentioned above are only an example of the present invention, therefore the processing method should not be limited only to those, but may be constructed in other sequences or processing methods.

For example, in the present embodiment mentioned in the above, the process comes into the operation for conducting the finalizing process from the screen (i.e., the navi screed) for displaying a list of the thumbnail pictures through the menu button, however that display of a list of the thumbnail pictures may be made on the way of the operation for conducting the finalizing process, but not shown at the first stage.

Also, in the present embodiments mentioned above, though the explanation was made only on the DVD-RAM, DVD-RW and DVD-R, but they should not be limited to those, and therefore other kinds of the optical discs can be applied thereto.

While we have shown and described several embodiments in accordance with our invention, it should be understood that the disclosed embodiments are susceptible of changes and modifications without departing from the scope of the invention. Therefore, we do not intend to be bound by the details shown and described herein but intend to cover all such changes and modifications falling within the ambit of the appended claims.

What is claimed is:

1. An optical disk recording/reproducing apparatus for recording video data onto a write-once type optical disk and for reproducing the video data recorded on the optical disk, comprising:
a thumbnail picture producing portion configured to produce a thumbnail picture representative of the video data;
an output portion configured to output the thumbnail picture;
a finalizing processing portion configured to finalize disk management information of the optical disk such that play back of the recorded video data on the optical disk is possible on another video player; and
a finalizing processing instruction portion operative with the finalizing processing portion and configured to receive from a user a selection indication to perform finalizing processing and to control execution of finalizing processing in response to receiving the selection indication,
wherein the selection indication is received during a time when the thumbnail picture is not being displayed on a display means by the output portion,
wherein the output portion displays the thumbnail picture on the display means subsequent to receiving the selection indication.

2. The optical disk recording/reproducing apparatus according to claim 1, wherein the output portion further displays the thumbnail picture on the display means at a time prior to execution of finalizing processing.

3. The optical disk recording/reproducing apparatus according to claim 1, wherein the output portion outputs an indication of the type of the optical disk.

4. The optical disk recording/reproducing apparatus according to claim 1, wherein the output portion outputs an indication which discriminates whether the execution of finalizing processing is performed on write-once type optical disk or not.

5. An optical disk recording/reproducing apparatus for recording video data onto a write-once type optical disk and for reproducing the video data recorded on the optical disk, comprising:
a thumbnail picture producing portion producing a thumbnail picture representing the video data;
an output portion outputting the thumbnail picture;
a finalizing processing portion configured to finalize disk management information of the optical disk such that play back of the recorded video data on the optical disk is possible on another video player; and
a finalizing processing instruction portion to receive an indication to perform finalizing processing and controlling execution of the finalizing processing in response thereto,
wherein when the indication to perform finalizing processing is received at a time when the thumbnail picture is not being displayed on a display means, then the output portion outputs the thumbnail picture on the display means.

6. The optical disk recording/reproducing apparatus according to claim 5, wherein when the indication to perform finalizing processing is received at a time when the thumbnail picture is not being displayed on a display means, the output portion outputs the thumbnail picture on the display means before the execution of finalizing processing is started.

7. An optical disk recording/reproducing apparatus for recording video data onto a write-once type optical disk and for reproducing the video data recorded on the optical disk, comprising:
a thumbnail picture producing portion producing a thumbnail picture representing the video data;
an output portion outputting the thumbnail picture;
a finalizing processing portion configured to finalize information relating to disk management of the optical disk such that play back of the recorded video data on the optical disk is possible on another video player; and
a finalizing processing instruction portion to receive an indication to perform finalizing processing and controlling execution of the finalizing processing in response thereto, wherein the output portion outputs the thumbnail picture on a display means prior to execution of the finalizing processing in which the thumbnail picture is not being displayed.

8. The optical disk recording/reproducing apparatus according to claim 7 wherein the output portion further outputs the thumbnail picture on the display means subsequent to receiving an indication to perform finalizing processing.

9. An optical disk recording/reproducing apparatus, for recording video data onto a write-once type optical disk, and for reproducing the video data recorded on the optical disk, comprising:
a thumbnail picture producing portion producing a thumbnail picture representing the video data;
an output portion outputting the thumbnail picture;
a finalizing processing portion configured to finalize information relating to disk management of the optical disk such that play back of the recorded video data on the optical disk is possible on another video player; and
a finalizing processing instruction portion configured to control execution of the finalizing processing,
wherein when an indication to perform finalizing processing is received, then the output portion outputs the thumbnail picture on a display means if the thumbnail picture is not being displayed at the time of receiving the indication to perform finalizing processing.

10. The optical disk recording/reproducing apparatus according to claim 9 wherein the output portion further outputs the thumbnail picture on the display means prior to commencing with execution of the finalizing processing.
